(19) United States
(12) Patent Application Publication
(10) Pub. No.: US 2014/0153880 A1
(43) Pub. Date: Jun. 5, 2014

(54) DEVICE AND METHOD FOR BUNDLING OPTICAL FIBERS

(71) Applicant: GENERAL ELECTRIC COMPANY, Schenectady, NY (US)

(72) Inventors: Leland Fraser Rindge, Auburn, NY (US); Theodore Alexander Chilek, Skaneateles, NY (US)

(73) Assignee: General Electric Company, Schenectady, NY (US)

(21) Appl. No.: 13/690,844

(22) Filed: Nov. 30, 2012

(51) Int. Cl. G02B 6/04; B32B 37/12

(52) U.S. Cl. CPC G02B 6/04; B32B 37/1284
USPC 385/80; 156/293

(57) ABSTRACT

The subject matter disclosed herein relates to a device and method for bundling optical fibers. The device has a receiving channel with a cavity for receiving the optical fibers. A cover with a protrusion is configured to be inserted into the cavity for compression of the optical fibers. The receiving channel has at least one hole in the receiving channel or the cover configured to receive any excess adhesive resulting from the compression of the optical fibers.

### BACKGROUND OF THE INVENTION

The subject matter disclosed herein relates to optical fiber bundles and methods for making optical fiber bundles.

Optical fiber bundles provide a mechanism for transferring light from a light source to a desired location. Such optical fiber bundles are utilized in a variety of fields including fiber-optic communications as well as illumination applications (e.g., medical applications, machining applications, and the like). For example, optical fibers may be used in flexible borescopes to illuminate a confined space and permit visualization.

Optical fiber bundles are connected to a light source, such as a light emitting diode (LED). The optical fiber bundles are comprised of multiple optical fibers. As light leaves the light source, a portion of the emitted light enters each optical fiber that comprises the optical fiber bundle. A portion of this light is then transferred down the length of the optical fiber bundle to a remote terminus. The light exits the terminus and illuminates the target. The amount of illumination provided is a function of the amount of light that enters the optical fiber bundle. It is desirable to provide a mechanism to reduce the loss of light. Conventionally, optical fibers are fused or epoxied to form optical fiber bundles. The fusing methods require expensive tooling and high heat. The excessive heat can give rise to other processing problems. Epoxied fibers usually have lower packing fraction with around 30% lost light (i.e., 70% core packing fraction).

The discussion above is merely provided for general background information and is not intended to be used as an aid in determining the scope of the claimed subject matter.

### BRIEF DESCRIPTION OF THE INVENTION

The subject matter disclosed herein relates to a device and method for bundling optical fibers. The device has a receiving channel with a cavity for receiving the optical fibers. A cover with a protrusion is configured to be inserted into the cavity for compression of the optical fibers. The receiving channel has at least one hole in the receiving channel or the cover configured to receive any excess adhesive resulting from the compression of the optical fibers.

In a first exemplary embodiment, a ferrule for bundling optical fibers is disclosed. The ferrule comprises a receiving member with a receiving channel comprising a cavity for receiving the optical fibers. The ferrule includes a cover with a protrusion configured to be inserted into the cavity to compress the optical fibers. At least one hole is present in the receiving channel or the cover that receives any excess adhesive resulting from the compression of the optical fibers.

In a second exemplary embodiment, an optical fiber bundle is disclosed. The optical fiber bundle comprises a plurality of elongated optical fibers with a ferrule disposed on an end portion thereof. The first ferrule comprises a receiving member with a receiving channel comprising a cavity for receiving the optical fibers. The ferrule includes a cover comprising a protrusion configured to be inserted into the cavity to compress the optical fibers. At least one hole is present in the receiving channel or the cover that receives any excess adhesive resulting from the compression of the optical fibers.

In a third exemplary embodiment, a method for bundling optical fibers is disclosed. The method comprises the steps of disposing an end portion of an optical fiber within a receiving channel of a receiving member of a ferrule. The receiving channel comprises a cavity for receiving the optical fibers. An adhesive is introduced into the receiving channel. A cover with a protrusion is placed over the receiving channel and inserted into the cavity to compress the optical fibers. Excess adhesive is permitted to flow through a hole in the receiving channel or the cover that is configured to receive any excess adhesive resulting from the compression. The adhesive is permitted to set.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is an exemplary schematic depiction of a system for illuminating a target location using a borescope;

FIG. 2 is a cross-section view of an exemplary optical fiber;

FIG. 3 is a depiction of an optical fiber bundle that is comprised of a plurality of optical fibers;

FIG. 4 is a cross-section view of the first ferrule of FIG. 1;

FIG. 5 is a perspective view of the first ferrule of FIG. 1 showing holes;

FIG. 6 is a depiction of a ferrule where the receiving channel has a U-shape;

FIG. 7 is a depiction of a ferrule where the receiving channel has a circular shape;

FIG. 8 is a depiction of a ferrule with multiple chambers;

FIG. 9 is a flow diagram of one method of bundling optical fibers; and

FIG. 10 is a depiction of another ferrule with multiple chambers.

### DETAILED DESCRIPTION OF THE INVENTION

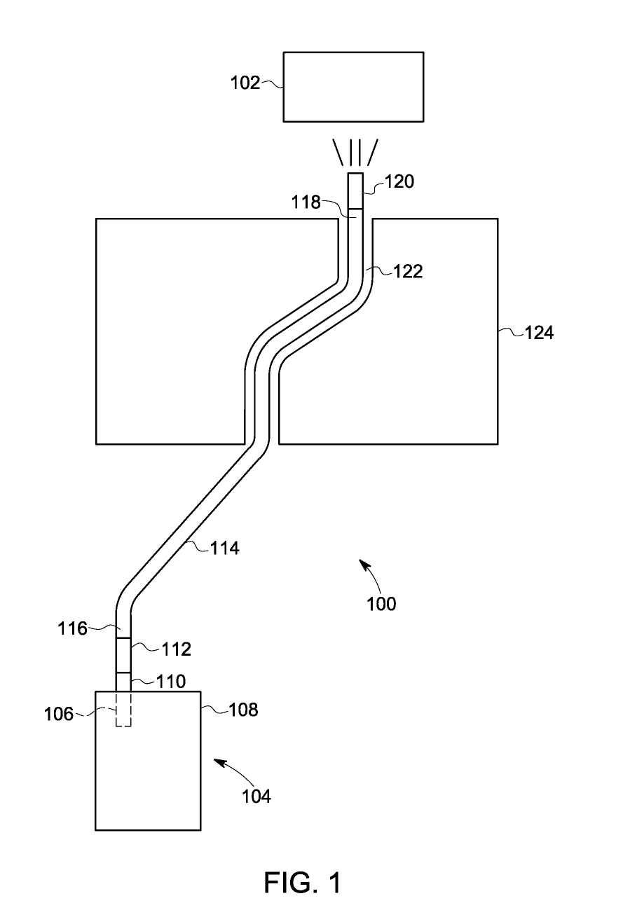

FIG. 1 is an exemplary schematic depiction of a system 100 for illuminating a target location 102 using a borescope 104. The borescope 104 comprises a light source 106 disposed within a housing 108. Examples of suitable light sources include light emitting diodes (LEDs), arc lamps, and the like. The housing 108 comprises a fitting 110. The fitting 110 is shaped to releasably receive a first ferrule 112 that connects to an optical fiber bundle 114.

Light from the light source 106 traverses the length of optical fiber bundle 114 from a first end portion 116 to a second end portion 118 where it exits a second ferrule 120. The second ferrule 120 is substantially identical to the first ferrule 112. Since the optical fiber bundle 114 is flexible, it can be maneuvered in or through a curved pathway 122 in device 124 to illuminate the target location 102. In the exemplary embodiment of FIG. 1, the first ferrule 112 compresses the optical fibers which comprise the optical fiber bundle to minimize the amount of lost light.

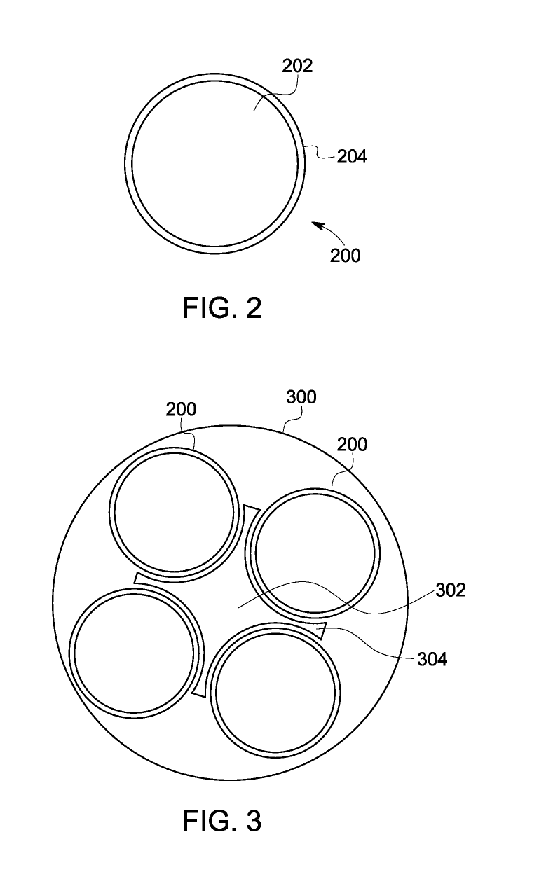

FIG. 2 is a cross-section view of an exemplary optical fiber 200. The optical fiber 200 comprises an optically transparent core 202 and a cladding 204. Space-limited illumination optical fibers attempt to maximize the cross-section area of the core 202 while minimizing the cross-section area of the cladding 202. Any light that contacts the cladding 204 is not transmitted by the optical fiber bundle and is lost.

As shown in FIG. 3, an optical fiber bundle 300 is comprised of a plurality of optical fibers 200 separated by gaps 302. Any light that enters the gaps 302 is not transmitted through the length of the optical fiber bundle 300 and is lost, typically as radiated heat. Conventional epoxy packing, wherein the gaps 302 are filled with epoxy, provides about 70% core packing fraction wherein 70% of the cross sectional area is occupied by the core 202 and the remaining 30% is occupied by the cladding 204 and the gaps 302. Packing by fusing provides about 90% core packing fraction but requires expensive tooling and undesirably high heat. As shown in FIG. 3, an adhesive 304 can be added in the gaps 302.

The first ferrule 112 (see FIG. 1) provides a mechanism to tightly pack the optical fibers 200 when forming an optical fiber bundle 300. The resulting optical fiber bundle 300 exceeds the core packing fraction of conventional epoxy packed bundles but does not require the expensive processing conditions of packing by fusing.

The shape of the first ferrule 112 is designed to match the shape and size of a corresponding light source outlet. For example, a particular light source (e.g., an LED) may have a rectangular shape. Conventionally, a circular optical fiber bundle fails to capture the light that is emitted from the corners of such a rectangular light source. This results in a portion of the light from the light source being lost. Loss of a portion of the light wastes energy, results in excessive heat and is undesirable. Advantageously, the shape of the first ferrule 112 may be controlled to better match the shape of the light source. This results in a more efficient use of the light from the light source.

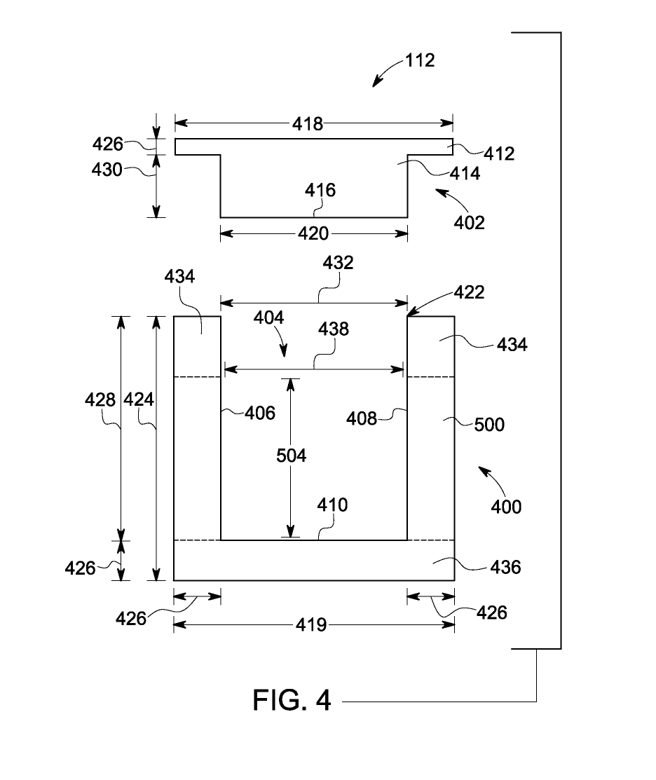

FIG. 4 depicts a cross-section of the first ferrule 112 taken perpendicular to the axis of optical fiber bundle 114. In the embodiment of FIG. 4, the first ferrule 112 has a rectangular shape. The first ferrule 112 comprises a receiving member 400 and a cover 402. The receiving member 400 comprises a receiving channel 404 with a cavity 422 for receiving a plurality of optical fibers 200 (see FIG. 2). Collectively, these optical fibers 200 form the optical fiber bundle 300 (see FIG. 3). The receiving channel 404 is formed by three surfaces of the receiving member 400 including a first surface 406, a second surface 408 and a third surface 410. In the exemplary embodiment depicted, the first surface 406 and the second surface 408 are both connected to the third surface 410 to form a monolithic receiving member 400. In the exemplary embodiment, the cover 402 comprises a lid 412 and a protrusion 414 that extends from the lid 412 to provide a fourth surface 416. The cover 402 can be monolithic with the lid 412 and protrusion 414 integrated into a single piece. In the exemplary embodiment, the protrusion 414 is a flat protrusion and has a width 420 that is slightly smaller than a width 432 of the cavity 422 to permit the protrusion 414 to securely mate with the cavity 422. While in the exemplary embodiment, the cover 412 comprises a lid 414 having a width 418 that is larger than the width 420 of the protrusion 414 and that is substantially the same width 419 as the receiving member 400, in another embodiment the cover 412 can be provided with a lid 414 that has a width 418 that is smaller than the width 420 of the protrusion 420. In yet another embodiment, the cover 412 can be provided without a lid 414, such that the cover 412 is of a substantially uniform width (i.e., the width 420 of the protrusion 416).

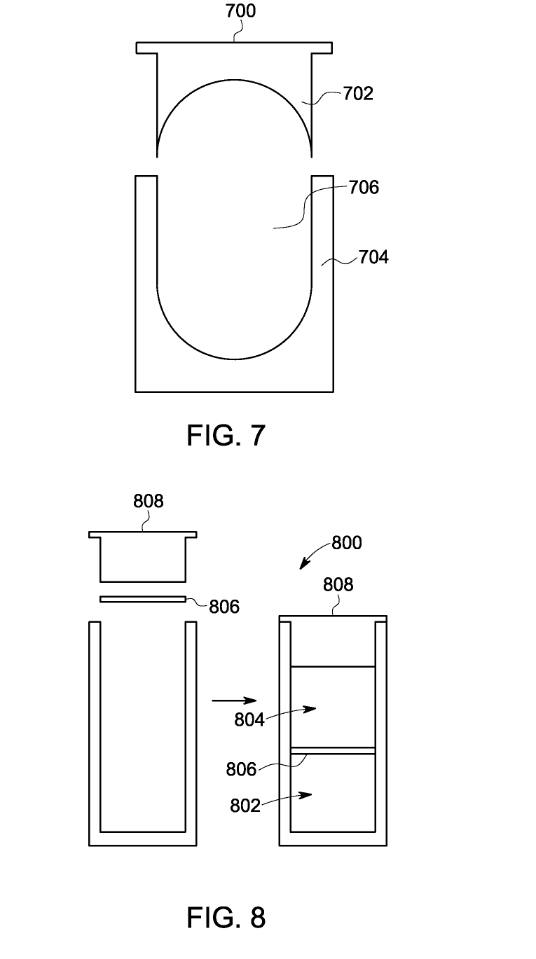

Referring again to the exemplary embodiment of FIG. 4, the lid 412 and the receiving member 400 can both have substantially the same width 418 to produce a ferrule with a substantially rectangular cross-section. The width 418 may be, for example 3.5 millimeters and the thickness 424 of the receiving member 400 may be, for example 4.0 millimeters. In another embodiment, the ferrule 112 has a substantially square cross-section. The sides 434 and bottom 436 of the first ferrule 112 may have a thickness 426 of 1.0 millimeters and receiving channel 404 may be 1.5 millimeters in width. In one embodiment, the width 438 of receiving channel 404 is uniform over its entire depth 428, including the width 432 of the cavity 422. In another embodiment, the width 438 of receiving channel 404 may increase or decrease over its depth 428. The lid 412 may have a thickness 426 that is 1.0 millimeters thick while the protrusion 414 may have a thickness 430 of, for example, 1.5 millimeters. The cross-sectional shape of the receiving channel 404 may be square, rectangular or any other suitable shape. Examples of other suitable cross-sectional shapes are shown in FIG. 6 and FIG. 7.

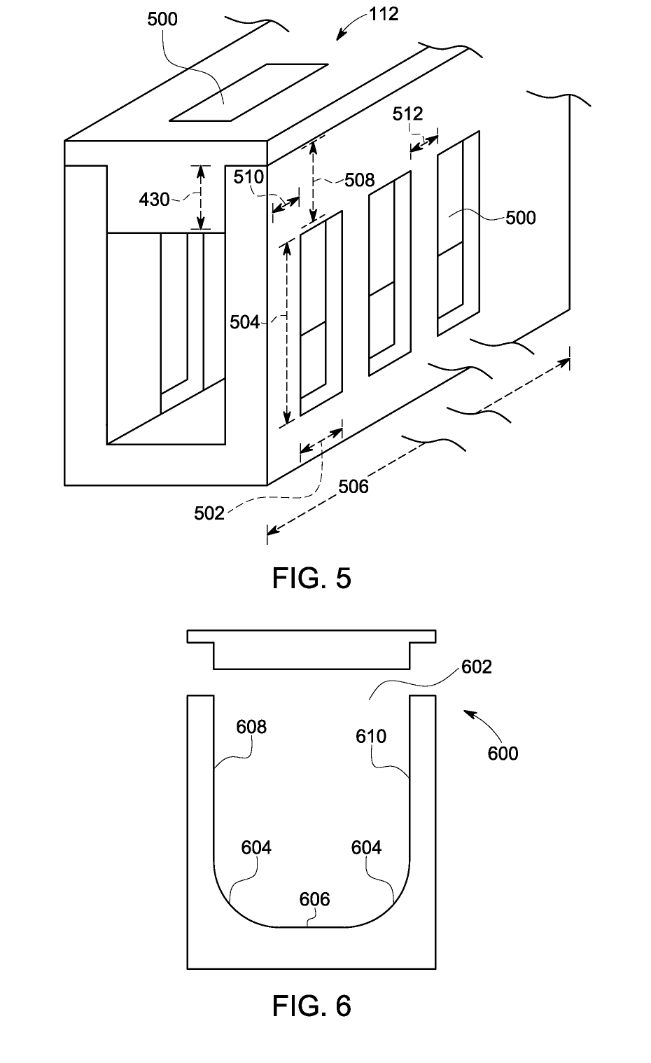

FIG. 5 is a perspective view of the first ferrule 112 showing holes 500. In the embodiment depicted, the holes 500 are rectangular with a width 502 and a height 504. In one embodiment, the holes 500 are rectangular with the width 502 being about 1.5 millimeters. In another embodiment, the holes are square. In yet another embodiment, the holes are circular. The first ferrule 112 has a length 506 which, in one embodiment, is about 18 millimeters. The holes 500 are spaced from the front and top surfaces, as viewed in FIG. 5 of first ferrule 112 by distances 508, 510. In one embodiment, the distance 508 is selected to correspond to the thickness 430 of the protrusion 414. In such an embodiment, the height 504 of the hole may be substantially equal to the depth 428 of the receiving channel 404 minus the thickness 430 of the protrusion 414. In one embodiment, distance 508 is about 1 millimeter and distance 510 is about three millimeters. Each of the holes 500 is spaced from an adjacent hole by a distance 512. In one embodiment, distance 512 is about 1.5 millimeters. In the exemplary embodiment of FIG. 5, the cover 402 comprises at least one hole 500.

In use, the optical fibers 200 (see FIGS. 2 and 3) are disposed within the receiving channel 404 and an adhesive 304 is added. In one embodiment, the optical fibers 200 are brushed with an adhesive 304. The cover 402 is then disposed above the receiving channel 404 and pressed in a downward direction such that the protrusion 416 compresses the optical fibers 200. This compression minimizes the gaps between the optical fibers 200. The adhesive 304 may be present in any remaining gaps 302 (see FIG. 3). The compression forces excess adhesive 304 into at least one hole 500 (see FIG. 5) to further minimize the gaps 302 between the optical fibers 200. A portion of the adhesive 304 contacts the protrusion 416. After the adhesive 304 cures, the cured adhesive 304 holds the cover 402 to the receiving member 400 to form first ferrule 112. In one embodiment, excess adhesive 304 cures within the holes 500. Examples of adhesives 304 include epoxies and other similar liquid fixing agents. In the exemplary embodiment depicted in the figures, the holes 500 are present on the first surface 406 and the second surface 408. In other embodiments, one or more holes may be present on the first surface 406, the second surface 408, the third surface 410, the fourth surface 416 and any combinations thereof

FIG. 6 is a depiction of a ferrule 600 where the receiving channel 602 has a U-shape cross-section formed by curved surfaces 604 that connect a third surface 606 to a first surface 608 and to a second surface 610 to provide the third surface 606 with a concave shape. The embodiment of FIG. 7 is similar to FIG. 6 except in that cover 700 has a protrusion 702 that is concave. When the cover 700 is connected to the receiving member 704 a circular receiving channel 706 is formed. In another embodiment, an elliptical receiving channel is formed.

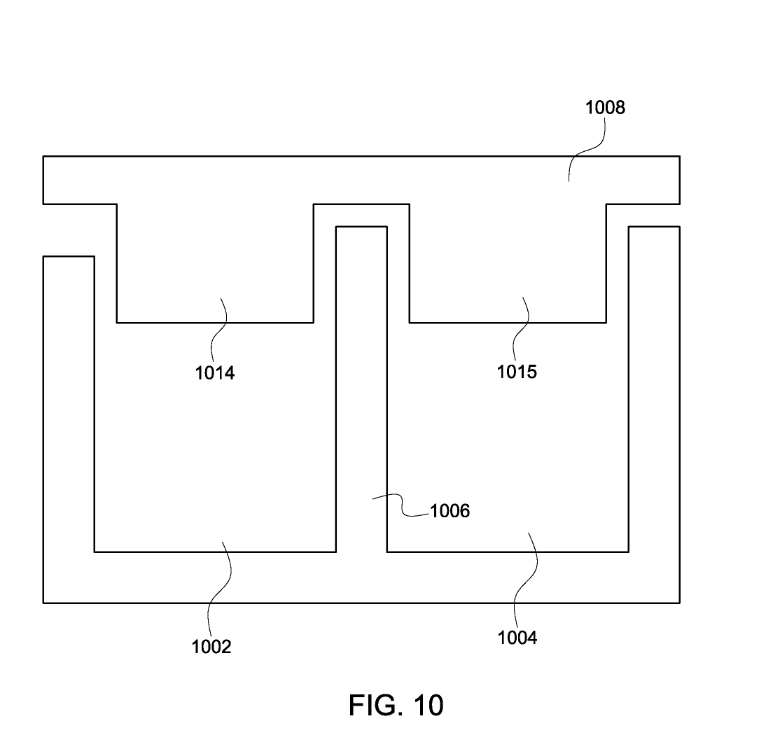

FIG. 8 is a depiction of a ferrule 800 with multiple chambers for multiple optical fiber bundles 300. In the exemplary embodiment, a first chamber 802 and a second chamber 804 are separated by a plate 806. Such multiple chambered ferrules are useful when a housing has multiple light sources. A first plurality of optical fibers are disposed within the first chamber 802. The plate 806 is then added to the ferrule. Thereafter a second plurality of optical fibers are disposed within the second chamber 804 before sealing with a cover 808. Such an embodiment is useful for preventing the first plurality and second plurality of optical fiber bundles 300 from being intermixed. When two light sources are used (e.g. two different wavelengths) separating the optical pathways permits controlled use of one of the two wavelengths. In the embodiment of FIG. 8, the plate 806 is horizontal such that the first chamber 802 and the second chamber 804 are vertically stacked. In such an embodiment, the plate 806 extends a direction that is substantially parallel to the cover 808. In another embodiment, shown in FIG. 10, the plate 1006 is vertical such that first and second chambers 1002, 1004 are horizontally arranged. In such an embodiment, the cover includes first and second protrusions that correspond to the first and second chambers. The plate 1006 extends in a direction that is substantially perpendicular to a cover 1008. In such embodiments, the plate may be a distinct piece with regard to the receiving member or the plate may be monolithic with regard to the receiving member. In the embodiment of FIG. 10, the cover 1008 comprises a first protrusion 1014 and a second protrusion 1015 configured to compress first chamber 1002 and second chamber 1004, respectively.

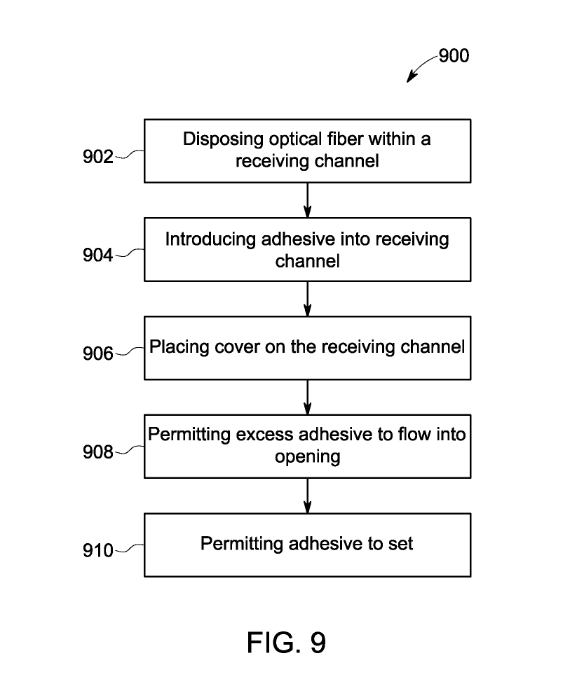

Referring to FIG. 9 and method 900 shown therein, in operation first ends of a plurality of optical fibers are disposed within a receiving channel of a ferrule in step 902. A liquid adhesive 304 is introduced into the receiving channel in step 904. The adhesive 304 may be introduced directly or the adhesive 304 may be introduced by first being brushed on the optical fibers. In step 906, a cover is placed on the receiving channel and pushed downward such that a protrusion on the cover compresses the optical fibers. Excessive adhesive 304 is permitted to flow into at least one hole in the ferrule in step 908. In step 910 the adhesive 304 is permitted to set. The first ends of the optical fibers may be subjected to cutting and polishing operations to produce smooth ends.

The ferrules described in this specification may be formed of any material that will withstand the operating temperature of the light source. In one embodiment, the ferrule is formed of a metal, such as aluminum, to better dissipate heat.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A ferrule for bundling optical fibers coated with an adhesive, the ferrule comprising:
a receiving member with a receiving channel comprising a cavity for receiving the optical fibers;
a cover comprising a protrusion configured to be inserted into the cavity of the receiving channel, the cover to compress the optical fibers; and
at least one hole in the receiving channel or the cover configured to receive any excess adhesive resulting from the compression of the optical fibers.

2. The ferrule of claim 1, wherein the receiving channel is formed by three surfaces, including a first surface, a second surface, and a third surface wherein the cavity of the receiving channel is defined by a gap between the first surface and the second surface.

3. The ferrule of claim 2, wherein the protrusion forms a fourth surface of the receiving channel that contacts both the first surface and the second surface.

4. The ferrule of claim 3, wherein the hole in the receiving channel is disposed on at least one surface selected from the group consisting of the first surface, the second surface, the third surface, the fourth surface, and combinations thereof

5. The ferrule of claim 3, wherein the fourth surface is a flat surface.

6. The ferrule of claim 3, wherein the fourth surface is a concave surface.

7. The ferrule of claim 1, wherein the cover further comprises a lid having a width that is larger than the width of the protrusion.

8. The ferrule of claim 1, wherein cover is of a substantially uniform width.

9. The ferrule of claim 2, wherein a plurality of holes are present on the first surface and the second surface.

10. The ferrule of claim 2, wherein the third surface has a concave surface.

11. The ferrule of claim 2, wherein the third surface is a flat surface.

12. The ferrule of claim 1, further comprising a plate disposed within the receiving channel, the plating dividing the receiving channel into a first compartment and a second compartment.

13. The ferrule of claim 12, wherein the plate extends in a direction that is substantially perpendicular to the cover.

14. An optical fiber bundle comprising:
a plurality of elongated optical fibers comprising a first end portion and a second end portion;
a first ferrule disposed on the first end portion, the first ferrule comprising:
a receiving member with a receiving channel comprising a cavity for receiving the optical fibers;
a cover comprising a protrusion configured to be inserted into the cavity of the receiving channel for compression of the optical fibers; and
at least one hole in the receiving channel or the cover configured to receive any excess adhesive resulting from the compression of the optical fibers.

15. The optical fiber bundle of claim 14, further comprising a second ferrule disposed on the second end portion of the optical fibers, the second ferrule being substantially identical to the first ferrule.

16. The optical fiber bundle of claim 14, wherein the receiving channel is formed by three surfaces, including a first surface, a second surface, and a third surface wherein the cavity of the receiving channel is defined by a gap between the first surface and the second surface, and wherein a plurality of holes are present on the first surface and the second surface.

17. The optical fiber bundle of claim 14, wherein the cover further comprises a lid having a width that is larger than the width of the protrusion.

18. The optical fiber bundle of claim 14, wherein the protrusion forms a fourth surface of the receiving channel that contacts both the first surface and the second surface, wherein the fourth surface is a flat surface.

19. The optical fiber bundle of claim 14, wherein the protrusion forms a fourth surface of the receiving channel that contacts both the first surface and the second surface, wherein the fourth surface is a concave surface.

20. A method for bundling optical fibers, the method comprising the steps of:
disposing a first end portion of an optical fiber within a receiving channel of a receiving member of a ferrule, the receiving channel comprising a cavity for receiving the optical fibers;
introducing an adhesive into the receiving channel;
placing a cover on the receiving channel, the cover comprising a protrusion configured to be inserted into the cavity of the receiving channel for compression of the optical fibers;
permitting excess adhesive to flow through a hole in the receiving channel or the cover that is configured to receive any excess adhesive resulting from the compression of the optical fibers; and
permitting the adhesive to set.
